(19) United States
(12) Patent Application Publication
(10) Pub. No.: US 2017/0372084 A1
(43) Pub. Date: Dec. 28, 2017

(54) PRINTING SYSTEM, ENCRYPTION KEY CHANGE METHOD, PRINTER, AND PROGRAM

(71) Applicant: KONICA MINOLTA, INC., Tokyo (JP)

(72) Inventor: Junya MURASHITA, Tokyo (JP)

(73) Assignee: KONICA MINOLTA, INC., Tokyo (JP)

(21) Appl. No.: 15/622,221

(22) Filed: Jun. 14, 2017

(30) Foreign Application Priority Data
Jun. 28, 2016 (JP) 2016-128061

(51) Int. Cl. G06F 21/60; G06F 3/12; H04L 9/16

(52) U.S. Cl. CPC G06F 21/608; H04L 9/16; G06F 21/602; G06F 3/1222; G06F 3/1238; G06F 3/1225; G06F 3/1286

(57) ABSTRACT

A printing system includes: a program of a printer drive; and printers, wherein the printing system encrypts part of a print job and transmits the print job to the printer, the printer includes a setting unit configured to receive a setting of a new encryption key, a storage unit, an encryption unit configured to generate new encryption key information, a search unit configured to search a network for a printer, a transmission unit configured to transmit the new encryption key information to the printer, a notification unit configured to notify the printer driver of apparatus information, a receiving unit configured to receive the new encryption key information, a decryption unit configured to decrypt the new encryption key information, and a change unit configured to change an encryption key, and the program of the printer driver acquires the new encryption key, and changes an encryption key to the new encryption key.

The entire disclosure of Japanese Patent Application No. 2016-128061 filed on Jun. 28, 2016 including description, claims, drawings, and abstract are incorporated herein by reference in its entirety.

### BACKGROUND OF THE INVENTION

### Field of the Invention

The present invention relates to a printing system, including a program of a printer driver to be installed on a server and executed, and a printer, to encrypt at least part of a print job and transmit the print job from the printer driver to the printer, an encryption key change method for changing an encryption key to be used in the printing system, the printer, and the program of the printer driver.

### Description of the Related Art

A print job to be transmitted from a printer driver on a server to a printer is encrypted to increase printing security. For example, information, such as a password for a security printing or user authentication function to be output as PJL (Printer Job Language), of the print job is encrypted.

Generally, a default encryption key unique to each series of models is provided as an encryption key to be used for the encryption and decryption. Upon shipping from the factory, the default encryption key is set as an encryption key that is normally used.

On the other hand, a client's administrator may change the default encryption key to an arbitrary encryption key. It is necessary to change both encryption keys set for the main body of a printer and a printer driver to change the default encryption key to the arbitrary encryption key.

Examples of use scenes in which the encryption key is changed include the following cases:
A case where a common driver (universal printer driver) is being used as the printer driver, and it is not desired to change the printer driver to the latest when the main body of the printer is replaced with the latest model. In this case, the common driver does not know a default encryption key of the latest model. Accordingly, the administrator sets an arbitrary encryption key.
A case where the use of a default encryption key is unacceptable as it is due to the client's security polity.
A case where a different encryption key is used according to the department.

In a case of a large-sized client company, several tens of the same model may be used, and their printer drivers may be installed onto a print server and administered. When such a client changes a default encryption key to an arbitrary encryption key, the change is to be made manually for all of the several tens of printers and the printer drivers installed on the print server, which requires time and trouble for administration.

JP 2008-181518 A discloses a technology for securely cloning (Cloning) the settings of a plurality of printers on a network. If any given printer is set, the technology allows data indicating the setting contents to be encrypted and transferred to another printer for setting.

If all encryption keys of several tens of printers and printer drivers installed on a print server are changed manually, it requires enormous amounts of time and trouble for the work.

Even if the technology disclosed in JP 2008-181518 A is applied, the encryption keys of the printer drivers cannot be changed.

### SUMMARY OF THE INVENTION

The present invention has been made in an attempt to solve the above problem, and an object thereof is to provide a printing system, an encryption key change method, a printer, and a program of a printer driver that can efficiently change encryption keys of a plurality of printers of the same model and printer drivers installed on a server to any value designated by a user, and can reduce the burden of the change on an administrator.

The gist of the present invention to achieve such an object is in the following aspects of the invention:

[1] To achieve the abovementioned object, according to an aspect, a printing system reflecting one aspect of the present invention comprises:
a program of a printer driver installed on a server to be executed; and
printers, wherein
the printing system encrypts at least part of a print job and transmits the print job from the printer driver to the printer,
the printer includes
   a setting unit configured to receive a setting of a new encryption key,
   a storage t in which an encryption key is stored,
   an encryption unit configured to generate new encryption key information obtained by encrypting the new encryption key set by the setting unit with a default encryption key common to the same model, the default encryption key being stored in the storage unit,
   a search unit configured to search a network for a printer of the same model as the printer itself,
   a transmission unit configured to transmit the new encryption key information to the printer detected by the search,
   a notification unit configured to notify the printer driver on the server of apparatus information identifying the printer detected by the search,
   a receiving unit configured to receive the new encryption key information from another printer,
   a decryption unit configured to decrypt the new encryption key information with the default encryption key, and
   a change unit configured to change an encryption key to be used for decryption of a print job to the encryption key obtained by decrypting the new encryption key information, and
the program of the printer driver
   acquires the new encryption key, and
   changes, to the new encryption key, an encryption key to be used for encryption of a print job to be transmitted to the printer indicated in the notified apparatus information.

In the above aspect and an aspect described below in Item. 5 of the invention, a new encryption key is simply input once into each of one printer and its printer driver to enable change of encryption keys of all printers of the same model as the one printer and all their corresponding printer drivers.

The new encryption key is encrypted with a default encryption key, and accordingly is securely transmitted on a network. Moreover, the default encryption key is common to the same model; accordingly, the printers of the same model can correctly perform decryption.

[2] To achieve the abovementioned object, according to an aspect, a printing system reflecting one aspect of the present invention comprises:
a program of a printer driver installed on a server to be executed; and
printers, wherein
the printing system encrypts at least part of a print job and transmits the print job from the printer driver to the printer,
the printer includes
   a setting unit configured to receive a setting of a new encryption key,
   a storage unit in which an encryption key is stored,
   a second encryption unit configured to generate default encryption key information obtained by encrypting a default encryption key common to the same model, the default encryption key being stored in the storage unit, with the new encryption key set by the setting unit,
   a search unit configured to search a network for a printer of the same model as the printer itself, and
   a notification unit configured to notify the printer driver on the server of apparatus information identifying the printer detected by the search and the default encryption key information,
the program of the printer driver
   acquires the new encryption key,
   changes, to the new encryption key, an encryption key to be used for encryption of a print job to be transmitted to the printer indicated in the notified apparatus information,
   decrypts the notified default encryption key information with the new encryption key,
   generates new encryption key information obtained by encrypting the new encryption key with the default encryption key obtained by the decryption, and
   transmits the new encryption key information to the printer indicated in the apparatus information, and
the printer further includes
   a receiving unit configured to receive the new encryption key information,
   a decryption unit configured to decrypt the new encryption key information with the default encryption key, and
   a change unit configured to change an encryption key to be used for decryption of a print job to the encryption key obtained by decrypting the new encryption key information.

In the above aspects and an aspect described below in Item. 6 of the invention, a new encryption key is simply input once into each of one printer and its printer driver to enable change of encryption keys of all printers of the same model as the one printer and all their corresponding printer drivers. A default encryption key is encrypted with the new encryption key to be transmitted from the printer to the printer driver. The printer driver encrypts the new encryption key with the default encryption key to distribute the encrypted new encryption key from the printer driver to the printers of the same model.

[3] The printing system of Item. 1, wherein
the notification unit preferably further notifies the printer driver on the server of the new encryption key information,
in acquiring the new encryption key, the program of the printer driver preferably receives the new encryption key information, decrypts the new encryption key information with the default encryption key, and acquires the new encryption key.

In the above aspects and an aspect described below in Item. 7 of the invention, if the printer driver knows a default encryption key, a new encryption key is encrypted with the default encryption key to be notified by the printer to the printer driver.

[4] The printing system of Item. 3, wherein upon changing an already changed encryption key to a new encryption key, the currently set encryption key is preferably used instead of the default encryption key.

In the above aspects and an aspect described below in Item. 8 of the invention, even if the printer driver does not know a default encryption key, when an encryption key has already been changed, both the printer and the printer driver know the changed encryption key. Accordingly, the changed encryption key is used instead of the default encryption key.

[5] To achieve the abovementioned object, according to an aspect, there is provided an encryption key change method for changing an encryption key to be used for encryption and decryption in a printing system that encrypts at least part of a print job and transmits the print job from a printer driver on a server to a printer, and the method reflecting one aspect of the present invention comprises:
causing the printer to
   receive a setting of a new encryption key,
   generate new encryption key information obtained by encrypting the new encryption key with a default encryption key common to the same model,
   search a network for a printer of the same model as the printer itself,
   transmit the new encryption key information to the printer detected by the search, and
   notify the printer driver on the server of apparatus information identifying the printer detected by the search;
causing the printer that has received the new encryption key information to decrypt the new encryption key information with the default encryption key, acquire the new encryption key, and change an encryption key to be used for decryption of a print job to the new encryption key; and
causing the printer driver on the server to
   acquire the new encryption key, and
   change, to the new encryption key, an encryption key to be used for encryption of a print job to be transmitted to the printer indicated in the notified apparatus information.

[6] To achieve the abovementioned object, according to an aspect, there is provided an encryption key change method for changing an encryption key to be used for encryption and decryption in a printing system that encrypts at least part of a print job and transmits the print job from a printer driver on a server to a printer, and the method reflecting one aspect of the present invention comprises:
causing the printer to
   receive a setting of a new encryption key,
   generate default encryption key information obtained by encrypting a default encryption key common to the same model with the new encryption key,
   search a network for a printer of the same model as the printer itself, and
   notify the printer driver on the server of apparatus information identifying the printer detected by the search and the default encryption key information;
causing the printer driver on the server to
   acquire the new encryption key,
   change, to the new encryption key, an encryption key to be used for encryption of a print job to be transmitted to the printer indicated in the notified apparatus information,
   decrypt the notified default encryption key information with the new encryption key,
   generate new encryption key information obtained by encrypting the new encryption key with the default encryption key obtained by the decryption, and
   transmit the new encryption key information to the printer indicated in the apparatus informations and
causing the printer that has received the new encryption key information to decrypt the new encryption key information with the default encryption key, acquire the new encryption key, and change an encryption key to be used for decryption of a print job to the new encryption key.

[7] The encryption key change method of Item. 5, wherein
the printer that has generated the new encryption key information preferably further transmits the new encryption key information to the printer driver on the server, and
in acquiring the new encryption key, the printer driver preferably receives the new encryption key information, decrypts the new encryption key information with the default encryption key, and acquires the new encryption key.

[8] The encryption key change method of Item. 7, wherein upon changing an already changed encryption key to a new encryption key, the currently set encryption key is preferably used instead of the default encryption key.

[9] To achieve the abovementioned object, according to an aspect, a printer in the printing system of any one of Items. 1 to 4, or a printer to execute the steps to be executed by the printer in the encryption key change method of any one of Items. 5 to 8, reflecting one aspect of the present invention is provided.

[10] To achieve the abovementioned object, according to an aspect, a non-transitory recording medium storing a computer readable program of a printer driver in the printing system of any one of Items. 1 to 4, or a non-transitory recording medium storing a computer readable program to cause the server to execute the steps to be executed by the printer driver in the encryption key change method of any one of Items. 5 to 8, reflecting one aspect of the present invention is provided.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a diagram showing an example of the configuration of a printing system according to embodiments of the present invention;

FIG. 2 is a block diagram showing a basic configuration of a printer to be used in the printing system according to the embodiments of the present invention;

FIG. 3 is a block diagram showing a functional configuration of a printer driver to be used in the printing system according to the embodiments of the present invention;

FIG. 4 is a flow diagram showing a process of changing a default encryption key to a new user-defined encryption key in the printing system according to a first embodiment of the present invention;

FIG. 5 is a diagram showing a list of the model names, IP addresses, and the like of printers on a network;

FIG. 6 is a diagram showing a list of apparatus information identifying the same model;

FIG. 7 is a diagram showing a list of print drivers (print queues) installed on a server;

FIG. 8 is a flow diagram showing a process of changing a default encryption key to a new user-defined encryption key in the printing system according to a second embodiment of the present invention;

FIG. 9 is the flow diagram continued from FIG. 8; and

FIG. 10 is a flow diagram showing a process of changing a default encryption key to a new user-defined encryption key in the printing system according to a third embodiment of the present invention.

### DESCRIPTION OF THE PREFERRED EMBODIMENTS

Hereinafter, embodiments of the present invention will be described with reference to the drawings. However, the scope of the invention is not limited to the illustrated examples.

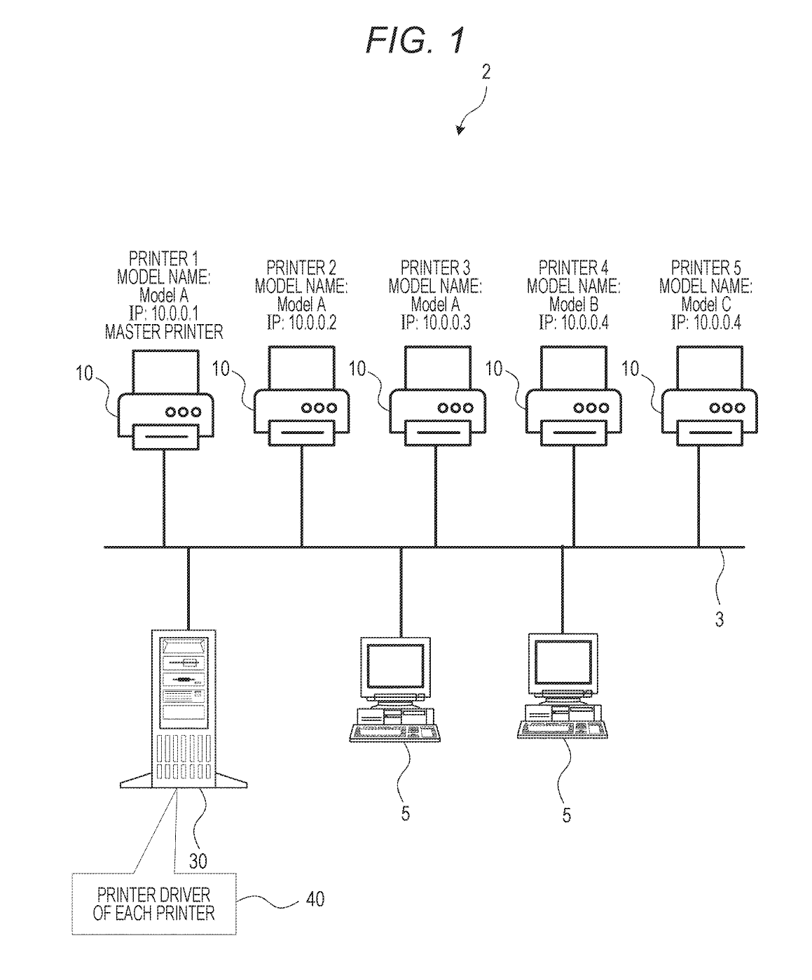

FIG. 1 is a diagram showing an example of a printing system 2 according to the embodiments of the present invention. The printing system 2 is configured, connecting one or more printers 10 and a server 30 to a network 3 such as a LAN (Local Area Network). One or more client terminals 5 are connected to the network 3.

The server 30 and the client terminal 5 are information processing apparatuses such as general personal computers, and are controlled by an OS.

In the printing system 2, a printer driver 40 corresponding to each printer 10 to be used has been install on the server 30.

When requesting any printer 10 to print, the client terminal 5 uses the printer driver 40 installed on the server 30, the printer driver 40 corresponding to the printer. The printer driver 40 installed on the server 30 generates a print job on the basis of the request of the client terminal 5, and transmits the print job to the printer 10 via the network. At this point in time, at least part of information on the print job such as a password to be used for security printing is encrypted and transmitted to the printer 10. The printer 10 that has received the print job prints in accordance with the contents of the print job. At this point in time, the encrypted information is decrypted with an encryption key held by the printer concerned.

In the embodiments, the printer 10 including only a print function is illustrated. However, it may be a multi-function peripheral including a copy function of optically reading a document and printing a duplicate image of the document on a recording sheet in addition to the print function. Alternatively, a printer and a multi-function peripheral may be present in combination on the network 3.

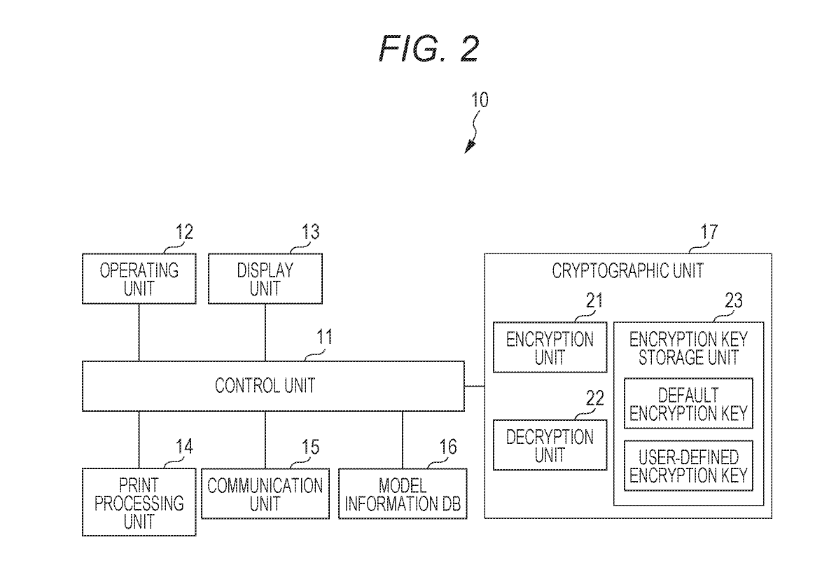

FIG. 2 is a block diagram showing a basic configuration of the printer 10. The printer 10 is configured connecting an operating unit 12, a display unit 13, a print processing unit 14, a communication unit 15, a model information DB 16, a cryptographic unit 17, and the like to a control unit 11.

The control unit 11 is configured including a CPU (Central Processing Unit) and storage units such as a ROM (Read Only Memory) and a RAM (Random Access Memory). The CPU operates in accordance with a program stored in the storage unit to control functions as the printer 10.

The operating unit 12 and the display unit 13 are provided to an operation panel of the printer 10. The display unit 13 includes a liquid crystal display (LCD. . . Liquid Crystal Display), and achieves a function to display various operation screens, a settings screen, and the like. The operating unit 12 includes hard keys such as a numeric keypad and a start button, and a touchscreen provided on a physical screen of the display unit 13.

The print processing unit 14 achieves a function to form and print an image corresponding to print data on a recording sheet. The print processing unit 14 includes, for example, a recording sheet conveying device, a photosensitive drum, a charging device, a laser unit, a developing device, a transfer and separation device, a cleaning device, and a fixing unit. The print processing unit 14 forms an image by an electrophotographic process.

The communication unit 15 achieves a function to communicate with external apparatuses such as the server 30 and the client terminal 5 via the network 3.

Information for determining whether or not the printer 10 found by searching the network 3 is the same model as the printer concerned is stored in the model information DB (database) 16. For example, an OID (Object ID) of an MIB (Management information Base) is used as the information.

The cryptographic unit 17 performs encryption and decryption processes. The cryptographic unit 17 includes an encryption unit 21 that performs the encryption process, a decryption unit 22 that performs the decryption process, and an encryption key storage unit 23 where an encryption key to be used for encryption and decryption is stored. A default encryption key set upon shipping from the factory, and a user-defined encryption key arbitrarily set by a user are stored in the encryption key storage unit 23. Upon shipping from the factory, the default encryption key is set as the encryption key to be used for encryption and decryption.

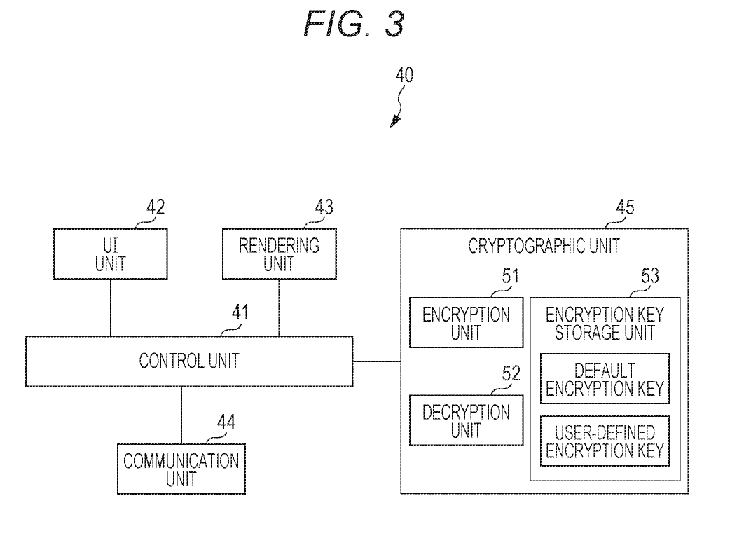

FIG. 3 is a block diagram showing a functional configuration of the printer driver 40. The server 30 executes a program of the printer driver installed on the above server 30 to achieve the functions of the printer driver 40. The printer driver 40 achieves the functions of a control unit 41, a UI unit 42, a rendering unit 43, a cormunication unit 44, and a cryptographic unit 45.

The control unit 41 controls modules of the printer driver 40 and passes data between the modules.

The UI unit 42 achieves a function to display a screen for allowing the user to operate the printer driver on a terminal of the user. Print settings and settings related options of the printer, and the like are performed through the screen.

The rendering unit 13 achieves a function to convert graphic data received from an application program such as a document creation program into print data in a format that is discernible by the printer 10. The rendering unit 43 changes the rendering content in accordance with the print settings that have been set using the UI unit 42.

The communication unit 44 communicates with various apparatuses connected via the network 3, such as the server 30 and the client terminal 5. The communication unit 44 communicates to, for example, transmit print data and acquire apparatus information.

The cryptographic unit 45 performs encryption and description processes. The cryptographic unit 45 includes an encryption unit 51 that performs the encryption process, a decryption unit 52 that performs the decryption process, and an encryption key storage unit 53 in which an encryption key to be used for encryption and decryption is stored. The same encryption key as the default encryption key that was set in the printer 10 of a model supported by the printer driver concerned upon shipping from the factory, and a user-defined encryption key arbitrarily set by the user are stored in the encryption key storage unit 53. The default encryption key is initially set to be used for encryption and decryption.

In a case of a universal printer driver, default encryption keys are stored in advance for all models prior to the issue of the universal printer driver in the encryption key storage unit 53. However, naturally, default encryption keys of printers of new models released after the issue of the universal printer driver are not stored.

Next, a description is given of the flow of a process upon changing a default encryption key to a new user-defined encryption key.

An encryption key to be used for a printer of a specific model and its printer driver is changed here. Let any given printer 10 of a target model for change of an encryption key be a master printer 10M.

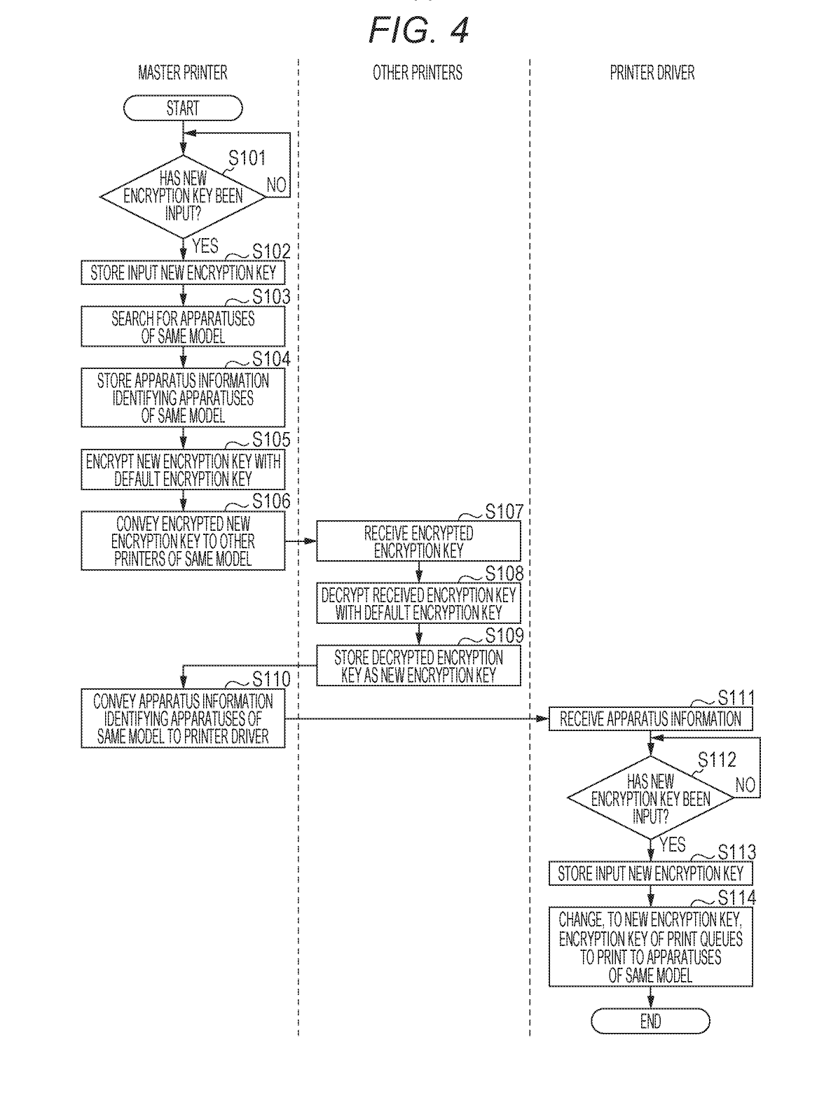

FIG. 4 is a flow diagram showing the process upon changing a default encryption key to a new user-defined encryption key. The master printer 10M judges whether or not the operating unit 12 and the display unit 13 have received an input of a new encryption key from a user (step S101). If a new encryption key has been input (step S101; Yes), the new encryption key is stored as a user-defined encryption key in the encryption key storage unit 23 of the cryptographic unit 17 (step S102). Consequently, the master printer 10M uses the new encryption key for encryption and decryption of a print job from then on.

Next, the printer 10 on the network 3 is searched to detect the printer 10 of the same model as the printer concerned (the master printer 10M) (step S103). Information identifying the printer 10 of the same model as the printer concerned (the master printer 10M) (apparatus information) is then stored (step S104). The apparatus information is assumed to be an IP address of the printer on the network 3.

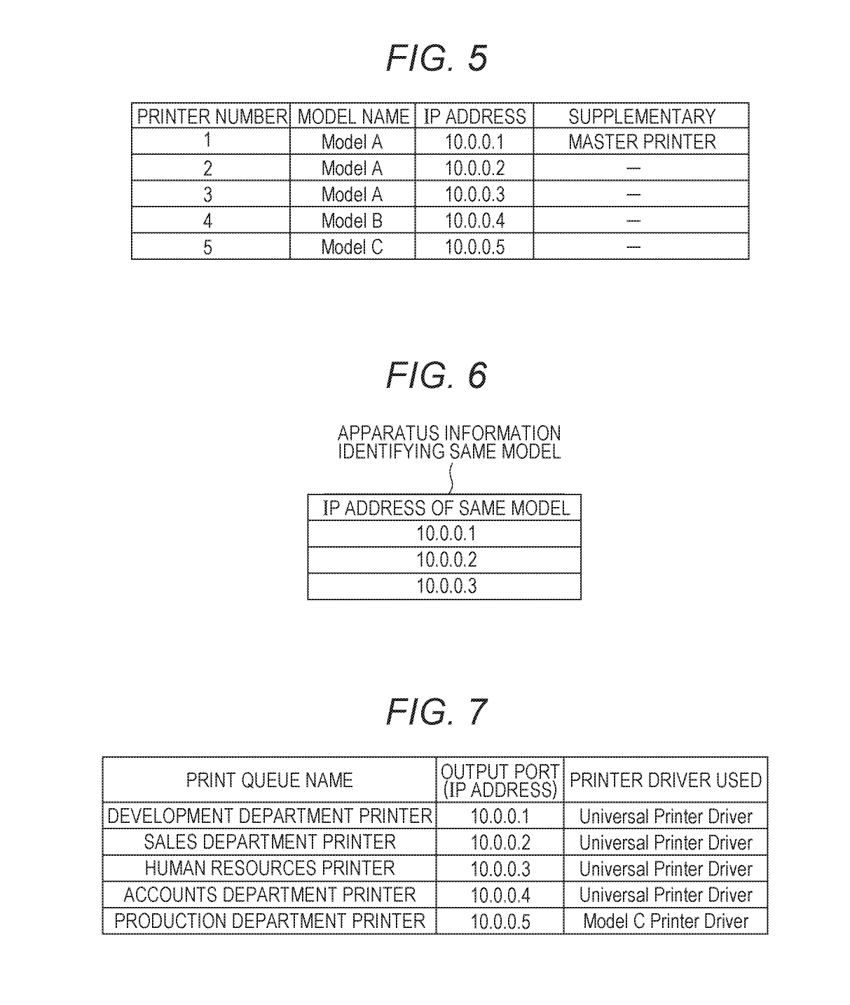

In this example, five printers 10 shown in FIGS. 1 and 5 are connected on the network 3. Among them, a printer with printer number 1 is the master printer 10M. The model of the master printer 10 is Model A. In addition to the master printer 10M, two printers with printer numbers 2 and 3 are present on the network 3 as printers of Model A. Therefore, three IP addresses of the printers with printer numbers 1 to 3 including the master printer 10M itself are stored as the apparatus information identifying the same model as shown in FIG. 6.

Next, the master printer 10M encrypts the new encryption key with a default encryption key (step S105). Information obtained by encrypting the new encryption key with the default encryption key is assumed to be new encryption key information.

The master printer 10M transmits (conveys) the new encryption key information to the printers other than the master printer 10M itself among the printers shown in the apparatus information stored in step S104 (step S106)

The printers of the same model as the master printer 10M other than the master printer 10M receive the new encryption key information transmitted from the master printer 10M (step S107). The received new encryption key information is then decrypted with a default encryption key held by the printers concerned (step S108). The same model has the same default encryption key. Accordingly, the new encryption key information can be correctly decrypted to obtain the new encryption key.

The other printers of the same model as the master printer 10M store the decrypted encryption key as a new encryption key (user-defined encryption key) in their own encryption key storage unit 23 (step S109). The new encryption key is used for encryption and decryption of a print job from then on.

The master printer 10M further transmits (conveys) the apparatus information stored in step S104 to the printer driver 40 (a printer driver corresponding to the master printer 10M) of the server 30 (step S110).

The above printer driver 40 receives the apparatus information from the master printer 10M (step S111). The UI unit 42 then displays a predetermined screen to receive the operation of inputting a new encryption key from the user (step S112). For example, the user who has input the new encryption key into the master printer 10M accesses the printer driver corresponding to the master printer 10M from the client terminal 5, displays the above screen, and inputs an encryption key with the same value as the new encryption key input into the master printer 10M.

The printer driver 40 stores the input new encryption key as a user-defined encryption key in the encryption key storage unit 53 (Step S113). A printer driver is installed here for each printer to create a print queue for each printer. Each print queue includes the encryption key storage unit 53. In step S113, the new encryption key is stored as the user-defined encryption key in the encryption key storage unit 53 of a print queue corresponding to the master printer 10M.

Next, the printer driver 40 identifies print queues corresponding to the printers indicated in the apparatus information received in step S111 on the basis of the apparatus information. The printer driver 40 stores the new encryption key as the user-defined encryption key in the encryption key storage units 53 of the identified print queues (step S114)

If, for example, the apparatus information shown in FIG. 6 has been received from the master printer 10M in a state where five print queues corresponding to the five printers of FIG. 5 have been installed on the server 30, as shown in FIG. 7, the new encryption key is stored for three print queues whose IP addresses of output ports are 10.0.0.1, 10.0.0.2, and 10.0.0.3, that is, print queues whose names are “Development Department Printer,” “Sales Department Printer,” and “Human Resources Department Printer.” The new encryption key is used for encryption and decryption from then on.

With the above processing, the encryption key change process ends. The new encryption key after the change is used for encryption and decryption of a print job from then on.

In this manner, when an encryption key is changed, a user simply inputs a new encryption key once into each of the master printer 10M and its corresponding printer driver 40 to enable the setting of the new encryption key for all printers of the same model as the master printer 10M and all their corresponding printer drivers (print queues) 40. Accordingly, the burden of the work related to the change of the encryption key can be reduced.

Next, a second embodiment of the present invention is described.

The basic configurations of the printer 10, the server 30, and the printer driver 40 are similar to those of the first embodiment. Their descriptions are omitted.

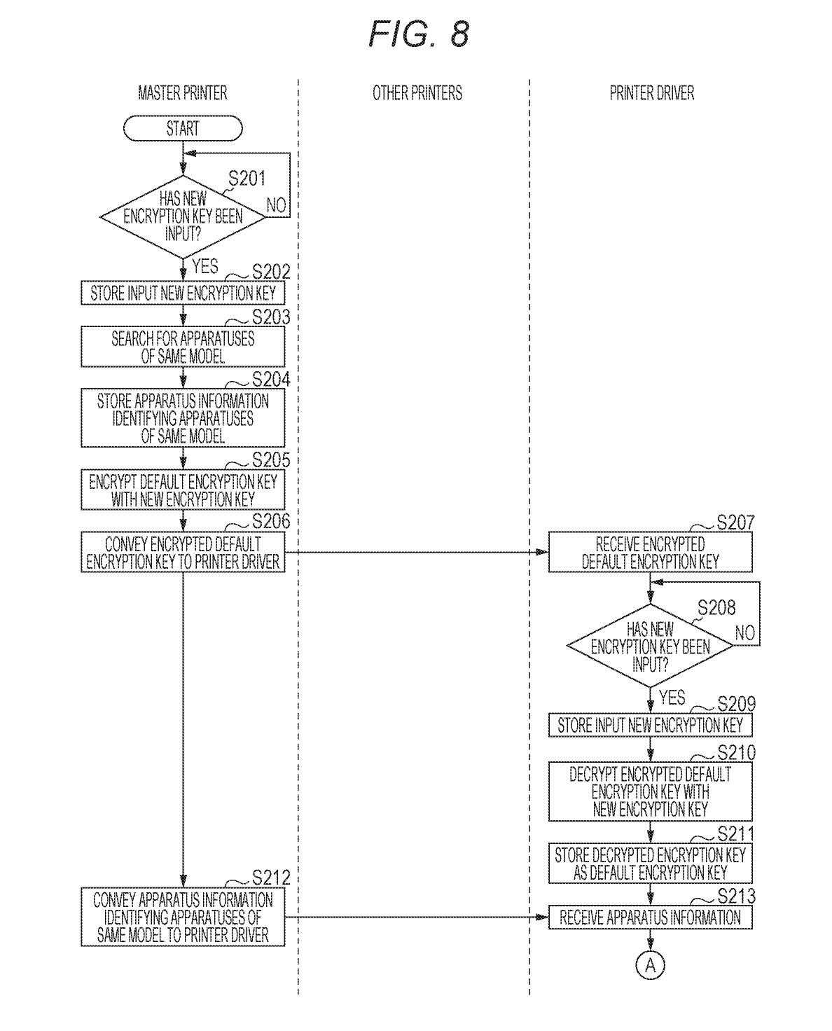

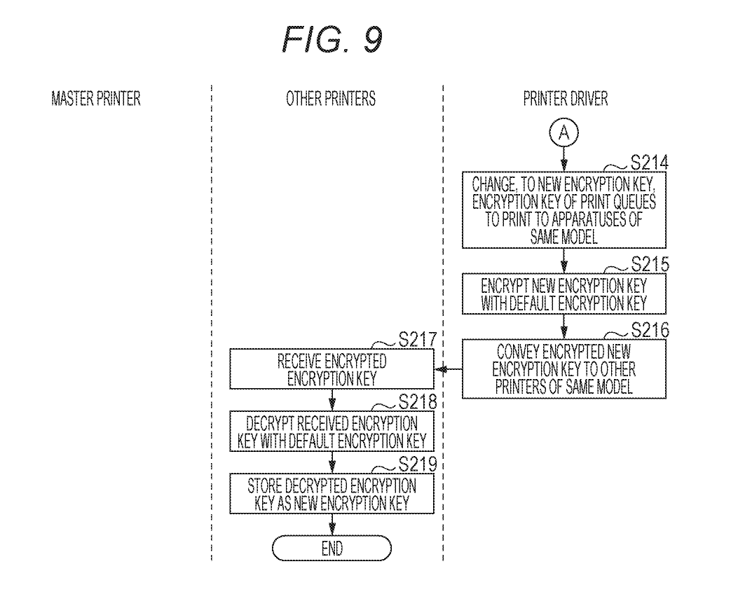

FIGS. 8 and 9 show the flow of a process upon changing a default encryption key to a new user-defined encryption key in the printing system 2 according to the second embodiment.

The second embodiment is similar to the first embodiment in the respect that a new encryption key is input once into each of the master printer 10M and its printer driver. However, in the second embodiment, the printer driver conveys the new encryption key to printers of the same model.

Firstly, the master printer 101 judges whether or not the operating unit 12 and the display unit 13 have received an input of a new encryption key from a user (Step S201). If a new encryption key has been input (Step S201; Yes), the new encryption key is stored as a user-defined encryption key in the encryption key storage unit 23 of the cryptographic unit 17 (step S202). Consequently, the master printer 10M uses the new encryption key for encryption and decryption of a print job.

Next, the printer 10 on the network 3 is searched to detect the printer 10 of the same model as the printer concerned (the master printer 10M) (step S203). Information identifying the printer 10 of the same model as the printer concerned (the master printer 10M) (apparatus information) is then stored. (step S204). The apparatus information is an IP address of the printer on the network 3.

In this example, the five printers 10 shown in. FIG. 5 are connected on the network 3 as in the first embodiment. The model of the master printer 10 is Model A. The one shown in FIG. 6 is stored as the apparatus information identifying the same model.

Next, the master printer 10M encrypts a default encryption key with the new encryption key (step S205). Information obtained by encrypting the default encryption key with the new encryption key is assumed to be default encryption key information. The master printer 10M transmits (conveys) the default encryption key information generated in step S205 to the printer driver 40 (the printer driver corresponding to the master printer 10M) of the server 30 (step S206).

The above printer driver 40 receives the default encryption key information from the master printer 10M (step S207). The UI unit 42 then displays a predetermined screen to receive the operation of inputting a new encryption key from the user (step S208). For example, the user who has input the new encryption key into the master printer 10M accesses the printer driver corresponding to the master printer 10M from the client terminal 5, displays the above screen, and inputs an encryption key with the same value as the new encryption key input into the master printer 10M.

The above printer driver 40 stores the input new encryption key as a user-defined encryption key in the encryption key storage unit 53 (Step S209). The new encryption key is stored here as the user-defined encryption key in the encryption key storage unit 53 of the print queue corresponding to the master printer 10M as in the first embodiment.

Next, the default encryption key information received in step S207 is decrypted with the new encryption key input in step S208 to acquire the default encryption key of the master printer 10M (step S210). The encryption key obtained by the decryption is then stored as a default encryption key in the encryption key storage unit 53 (step S211).

The master printer 10M further transmits (conveys) the apparatus information stored in step S204 to the printer driver 40 (the printer driver corresponding to the master printer 10M) of the server 30 (Step S212).

The above printer driver 40 receives the apparatus information from the master printer 10M (step S213). Print queues corresponding to the printers indicated in the received apparatus information are then identified on the basis of the apparatus information to store the new encryption key input in step S208 as a user-defined encryption key in the encryption key storage units 53 of the identified print queues (step S214).

Next, the new encryption key input in step S208 is encrypted with the default encryption key obtained by being decrypted in step S210 to generate new encryption key information (step S215). The new encryption key information is then transmitted (conveyed) to the printers indicated in the apparatus information received in S213 (the printers of the same model other than the master printer 10M) (step S216).

The printers of the same model as the master printer 10M other than the master printer 10M receive the new encryption key information transmitted from the printer driver 40 (step S217). The received new encryption key information is decrypted with a default encryption key held by the printers concerned (step S218). The same model has the same default encryption key. Accordingly, the new encryption key information can be correctly decrypted to obtain the new encryption key. The decrypted encryption key is stored as a new encryption key (user-defined encryption key) in the encryption key storage units 23 of the printers concerned (step S219). The new encryption key is used for encryption and decryption of a print job from then on.

In this manner, in the second embodiment, when an encryption key is changed, a user simply inputs a new encryption key once into each of a master printer and its corresponding printer driver to enable the setting of the new encryption key for all printers of the same model as the master printer 10M and all their corresponding printer drivers (print queues). Accordingly, the burden of the work related to the change of the encryption key can be reduced.

Next, a third embodiment of the present invention is described.

The first and second embodiments correspond to the case where the printer driver 40 installed on the server 30 does not the default encryption key of the master printer 10M. For example, they correspond to a case where a printer of a new model that is not supported by an existing universal printer driver has been introduced, but the existing universal printer driver continues being used. In other words, in this case, the existing universal printer driver does not know a default encryption key of the printer of the new model. Accordingly, a new encryption key set by an administrator is to be set as an encryption key to be used for the new model and the existing universal printer driver.

The third embodiment corresponds to a case where a printer driver already knows the default encryption key of the master printer 10M. The basic configurations of the printer 10, the server 30, and the printer driver 40 are similar to those of the first embodiment. Their descriptions are omitted.

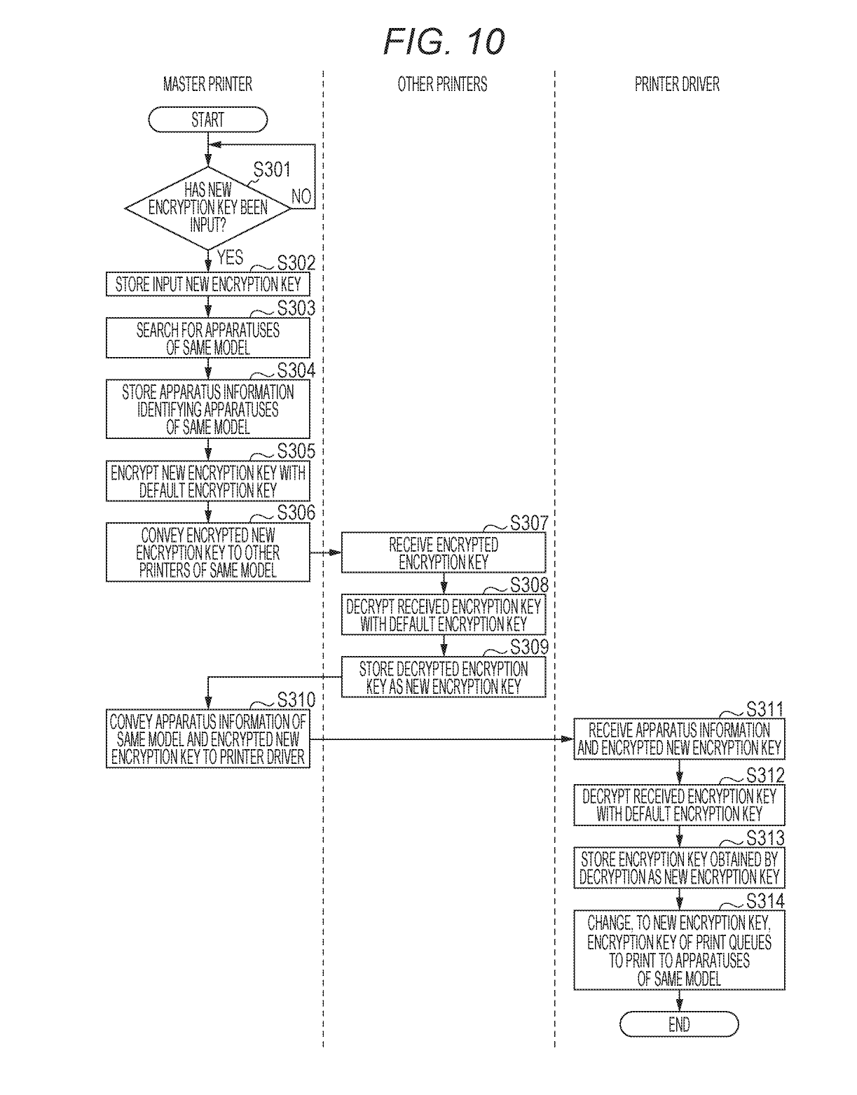

FIG. 10 shows the flow of a process upon changing a default encryption key to a new user-defined encryption key in the printing system 2 according to the third embodiment. The master printer 10M judges whether or not the operating unit 12 and the display unit 13 have received an input of a new encryption key from a user (step S301). If a new encryption key has been input (step S301; Yes), the new encryption key is stored as a user-defined encryption key in the encryption key storage unit 23 of the cryptographic unit 17 (step S302). Consequently, the master printer 10M uses the new encryption key for encryption and decryption of a print job.

Next, the printer 10 on the network 3 is searched to detect the printer 10 of the same model as the printer concerned (the master printer 10M) (step S303). Information identifying the printer 10 of the same model as the printer concerned (the master printer 10M) (apparatus information) is then stored (step S304). The apparatus information is assumed to be an IP address of the printer on the network 3.

Next, the master printer 10M encrypts the new encryption key with the default encryption key (step S305) Information obtained by encrypting the new encryption key with the default encryption key is assumed to be new encryption key information. The master printer 10M then transmits (conveys) the new encryption key information to the printers indicated in the apparatus information stored in step S304 other than the master printer 10M itself (step S306).

The printers of the same model as the master printer 10M other than the master printer 10M receive the new encryption key information transmitted from the master printer 10M (step S307). The received new encryption key information is then decrypted with a default encryption key held by the printers concerned (step S308). The same model has the same default encryption key. Accordingly, the new encryption key information can be correctly decrypted to obtain the new encryption key. The decrypted encryption key is subsequently stored as a new encryption key (user-defined encryption key) in the encryption key storage units 23 of the printers concerned (step S309). The new encryption key is used for encryption and decryption of a print job from then on.

The master printer 10M further transmits (conveys) the apparatus information stored in step S304 and the new encryption key information obtained by the encryption in step S305 to the printer driver 40 (the printer driver corresponding to the master printer 10M) of the server 30 (step S310).

The above printer driver 40 receives the apparatus information and the new encryption key information from the master printer 10M (step S311). The received new encryption key information is then decrypted with a default encryption key already held to acquire the new encryption key (step S312).

The above printer driver 40 stores the new encryption key obtained by the decryption as a user-defined encryption key in the encryption key storage unit 53 (step S313). Specifically, the new encryption key is stored as the user-defined encryption key in the encryption key storage unit 53 of the print queue corresponding to the master printer 10M.

Next, print queues corresponding to the printers indicated in the apparatus information received in step S311 are then identified on the basis of the apparatus information to store the new encryption key as a user-defined encryption key in the encryption key storage units 53 of the identified print queues (step S314).

With the above processing, the encryption key change process ends. The new encryption key after the change is used for encryption and decryption of a print job from then on.

In this manner, in the third embodiment, when an encryption key is changed, a user simply inputs a new encryption key once into a master printer to enable the setting of the new encryption key for all printers of the same model as the master printer 10M and all their corresponding printer drivers (print queues). Accordingly, the burden of the work related to the change of the encryption key can be reduced.

When, in a state where an encryption key to be used for encryption and decryption has already been changed by the process shown in the first or second embodiment from a default encryption key to a user-defined encryption key, the user-defined encryption key is further changed to another new encryption key afterward, the currently set user-defined encryption key may be used instead of the default encryption key to perform the process of FIG. 10. Once the user-defined encryption key is set, a printer and a printer driver enter a state of holding a common encryption key. Accordingly, the new encryption key can be encrypted with the common encryption key and conveyed from the printer to the printer driver.

Up to this point the embodiments of the present invention have been described with the drawings. However, specific configurations are not limited to those shown in the embodiments. The present invention includes modifications and additions that are within the scope that does not depart from the gist of the present invention.

In addition to the printing system of the embodiments, the encryption key change method of the embodiments, the printer in the printing system of the embodiments, the printer driver program in the printing system of the embodiments, and the like also correspond to the present invention.

Although the present invention has been described and illustrated in detail, it is clearly understood that the same is by way of illustrated and example only and is not to be taken by way of limitation, the scope of the present invention being interpreted by terms of the appended claims.

What is claimed is:

1. A printing system comprising:
a program of a printer driver installed on a server to be executed; and
printers, wherein the printing system encrypts at least part of a print job and transmits the print job from the printer driver to the printer,
the printer includes
a setting unit configured to receive a setting of a new encryption key,
a storage unit in which an encryption key is stored,
an encryption unit configured to generate new encryption key information obtained by encrypting the new encryption key set by the setting unit with a default encryption key common to the same model, the default encryption key being stored in the storage unit,
a search unit configured to search a network for a printer of the same model as the printer itself,
a transmission unit configured to transmit the new encryption key information to the printer detected by the search,
a notification unit configured to notify the printer driver on the server of apparatus information identifying the printer detected by the search,
a receiving unit configured to receive the new encryption key information from another printer,
a decryption unit configured to decrypt the new encryption key information with the default encryption key, and
a change unit configured to change an encryption key to be used for decryption of a print job to the encryption key obtained by decrypting the new encryption key information, and
the program of the printer driver
acquires the new encryption key, and
changes, to the new encryption key, an encryption key to be used for encryption of a print job to be transmitted to the printer indicated in the notified apparatus information.

2. A printing system comprising:
a program of a printer driver installed on a server to be executed; and
printers, wherein
the printing system encrypts at least part of a print job and transmits the print job from the printer driver to the printer,
the printer includes
a setting unit configured to receive a setting of a new encryption key,
a storage unit in which an encryption key is stored,
a second encryption unit configured to generate default encryption key information obtained by encrypting a default encryption key common to the same model, the default encryption key being stored in the storage unit, with the new encryption key set by the setting unit,
a search unit configured to search a network for a printer of the same model as the printer itself, and
a notification unit configured to notify the printer driver on the server of apparatus information. identifying the printer detected by the search and the default encryption key information,
the program of the printer driver
acquires the new encryption key,
changes, to the new encryption key, an encryption key to be used for encryption of a print job to be transmitted to the printer indicated in the notified apparatus information,
decrypts the notified default encryption key information with the new encryption key,
generates new encryption key information obtained by encrypting the new encryption key with the default encryption key obtained by the decryption, and
transmits the new encryption key information to the printer indicated in the apparatus information, and
the printer further includes
a receiving unit configured to receive the new encryption key information,
a decryption unit configured to decrypt the new encryption key information with the default encryption key, and
a change unit configured to change an encryption key to be used for decryption of a print job to the encryption key obtained by decrypting the new encryption key information.

3. The printing system according to claim 1, wherein
the notification unit further notifies the printer driver on the server of the new encryption key information,
in acquiring the new encryption key, the program of the printer driver receives the new encryption key information, decrypts the new encryption key information with the default encryption key, and acquires the new encryption key.

4. The printing system according to claim 3, wherein upon changing an already changed encryption key to a new encryption key, the currently set encryption key is used instead of the default encryption key.

5. An encryption key change method for changing an encryption key to be used for encryption and decryption in a printing system that encrypts at least part of a print job and transmits the print job from a printer driver on a server to a printer, the method comprising:
causing the printer to
receive a setting of a new encryption key,
generate new encryption key information obtained by encrypting the new encryption key with a default encryption key common to the same model,
search a network for a printer of the same model as the printer itself,
transmit the new encryption key information to the printer detected by the search, and
notify the printer driver on the server of apparatus information identifying the printer detected by the search;
causing the printer that has received the new encryption key information to decrypt the new encryption key information with the default encryption key, acquire the new encryption key, and change an encryption key to be used for decryption of a print job to the new encryption key; and
causing the printer driver on the server to
acquire the new encryption key, and
change, to the new encryption key, an encryption key to be used for encryption of a print job to be transmitted to the printer indicated in the notified apparatus information.

6. An encryption key change method for changing an encryption key to be used for encryption and decryption in a printing system that encrypts at least part of a print job and transmits the print job from a printer driver on a server to a printer, the method comprising:
causing the printer to
receive a setting of a new encryption key,
generate default encryption key information obtained by encrypting a default encryption key common to the same model with the new encryption key,
search a network for a printer of the same model as the printer itself, and
notify the printer driver on the server of apparatus information identifying the printer detected by the search and the default encryption key information;
causing the printer driver on the server to
acquire the new encryption key,
change, to the new encryption key, an encryption key to be used for encryption of a print job to be transmitted to the printer indicated in the notified apparatus information,
decrypt the notified default encryption key information with the new encryption key,
generate new encryption key information obtained by encrypting the new encryption key with the default encryption key obtained by the decryption, and
transmit the new encryption key information to the printer indicated in the apparatus information; and
causing the printer that has received the new encryption key information to decrypt the new encryption key information with the default encryption key, acquire the new encryption key, and change an encryption key to be used for decryption of a print job to the new encryption key.

7. The encryption key change method according to claim 5, wherein
the printer that has generated the new encryption key information further transmits the new encryption key information to the printer driver on the server, and
in acquiring the new encryption key, the printer driver receives the new encryption key information, decrypts the new encryption key information with the default encryption key, and acquires the new encryption key.

8. The encryption key change method according to claim 7, wherein upon changing an already changed encryption key to a new encryption key, the currently set encryption key is used instead of the default encryption key.

9. A printer in the printing system according to claim 1.

10. A printer to execute the steps to be executed by the printer in the encryption key change method according to claim 5.

11. A non-transitory recording medium storing a computer readable program of a printer driver in the printing system according to claim 1.

12. A non-transitory recording medium storing a computer readable program to cause the server to execute the steps to be executed by the printer driver in the encryption key change method according to claim 5.

13. A printer in the printing system according to claim 2.

14. A printer to execute the steps to be executed by the printer in the encryption key change method according to claim 6.

15. A non-transitory recording medium storing a computer readable program of a printer driver in the printing system according to claim 2.

16. A non-transitory recording medium storing a computer readable program to cause the server to execute the steps to be executed by the printer driver in the encryption key change method according to claim 6.
